(19) United States
(12) Patent Application Publication
(10) Pub. No.: US 2012/0154735 A1
(43) Pub. Date: Jun. 21, 2012

(54) METHOD FOR MANUFACTURING LIQUID CRYSTAL DISPLAY DEVICE AND LIQUID CRYSTAL DISPLAY DEVICE

(75) Inventor: Takuto KATO, Seto (JP)

(73) Assignee: FUJITSU LIMITED, Kawasaki (JP)

(21) Appl. No.: 13/232,308

(22) Filed: Sep. 14, 2011

(30) Foreign Application Priority Data
Dec. 21, 2010 (JP) 2010-284864

(51) Int. Cl. G02F 1/1333; H01J 9/24

(52) U.S. Cl. 349/158; 445/24

(57) ABSTRACT

A method for manufacturing a liquid crystal display device includes forming a structure on a first substrate, bonding a second substrate onto the structure to form a first space and a second space which are isolated by the structure between the first substrate and the second substrate, injecting a first liquid crystal material containing a photo-curable resin into one of the first space and the second space while selectively irradiating a boundary area of the first space and the second space with a light, and injecting a second liquid crystal material different from the first liquid crystal material into another one of the first space and the second space.

### CROSS-REFERENCE TO RELATED APPLICATION

This application is based upon and claims the benefit of priority of the prior Japanese Patent Application No. 2010-284864, filed on Dec. 21, 2010, the entire contents of which are incorporated herein by reference.

### FIELD

The embodiment discussed herein is related to a method for manufacturing a liquid crystal display device and a liquid crystal display device.

### BACKGROUND

For example, a reflective liquid crystal display panel for use in a full color electronic paper has three kinds of liquid crystal display elements into which liquid crystal materials which reflect light with wavelengths of different bands (RGB: Red-Green-Blue) are injected. The three kinds of liquid crystal display elements are individually manufactured, and then laminated on each other to serve as a liquid crystal display panel, such as an electronic paper. Therefore, the thickness of the liquid crystal display panel is about 3 times the thickness of the single liquid crystal display element and the manufacturing cost of the liquid crystal display panel is about 3 times the manufacturing cost of the single liquid crystal display element.

Then, in order to reduce the thickness and the manufacturing cost of the liquid crystal display panel, a so-called shared liquid crystal display element, which contains at least two liquid crystal materials of RGB into one liquid crystal display element so as to reduce the number of liquid crystal display elements, has been developed. The shared liquid crystal display element has two liquid crystal substrates and a wall portion which is disposed between the liquid crystal substrates and which divides the gap between the liquid crystal substrates into a plurality of spaces, in which liquid crystal materials, each reflects light in a corresponding wavelength band, are injected into the plurality of liquid crystal spaces (Japanese Laid-Open Patent Publication No. 9-251165).

The wall portion for use in the shared liquid crystal display element is very fine, and therefore defects often arise. When defects arises in the wall portion, adjacent liquid crystal spaces communicate, the plurality of liquid crystal materials injected into the shared liquid crystal display element are mixed, which deteriorates the display quality of the liquid crystal display panel. Therefore, when defects are found in the wall portion in manufacturing the liquid crystal display panel, the shared liquid crystal display element cannot be used.

### SUMMARY

According to an aspect of the invention, a method for manufacturing a liquid crystal display device includes forming a structure on a first substrate, bonding a second substrate onto the structure to form a first space and a second space which are isolated by the structure between the first substrate and the second substrate, injecting a first liquid crystal material containing a photo-curable resin into one of the first space and the second space while selectively irradiating a boundary area of the first space and the second space with a light, and injecting a second liquid crystal material different from the first liquid crystal material into another one of the first space and the second space.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a liquid crystal display device according to a first embodiment;

FIG. 2 is a cross sectional view of the liquid crystal display device according to the first embodiment;

FIG. 3 is a plan view of first and second liquid crystal display elements according to the first embodiment;

FIG. 4 is a partial cross-sectional view of the first and second liquid crystal display elements according to the first embodiment;

FIGS. 5A to 5E are views illustrating manufacturing processes of the first and second liquid crystal display elements according to the first embodiment;

FIG. 6 illustrates manufacturing processes of the first and second liquid crystal display elements according to the first embodiment;

FIGS. 7A and 7B are views illustrating manufacturing processes of the first and second liquid crystal display elements according to the first embodiment;

FIG. 8 illustrates a positional relation between the wall portion of the first and second liquid crystal display elements according to the first embodiment and openings of a photomask;

FIG. 9 is a view illustrating a process for injecting the first and second liquid crystal materials according to the first embodiment;

FIG. 10 is a view illustrating a process for injecting the first and second liquid crystal materials according to the first embodiment;

FIG. 11 is a table illustrating the results of an experiment in which a UV curable liquid crystal is cured by ultraviolet rays and illustrating the relationship between the flow rate of a liquid crystal material containing a UV curable liquid crystal with the same proportion as that of the first and second liquid crystal materials according to the first embodiment and the cured state of the UV curable liquid crystal;

FIG. 12 is a plan view of first and second liquid crystal display elements according to a second embodiment;

FIG. 13 is a view illustrating manufacturing processes of the first and second liquid crystal display elements according to the second embodiment;

FIG. 14 illustrates a positional relation between the wall portion of the first and second liquid crystal display elements according to the second embodiment and openings of a photomask; and

FIG. 15 is a view illustrating manufacturing processes of the first and second liquid crystal display elements according to a modification of the second embodiment.

### DESCRIPTION OF EMBODIMENTS

### First Embodiment

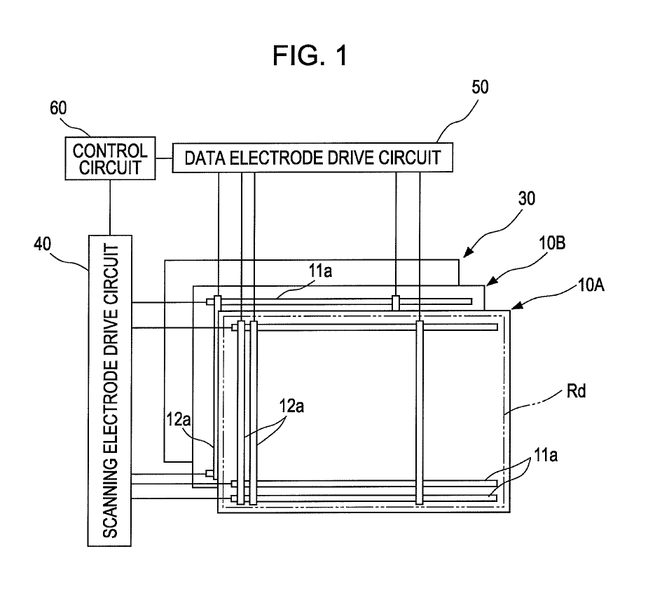

A first embodiment will be described with reference to FIGS. 1 to 11.

Configuration of Liquid Crystal Display Device

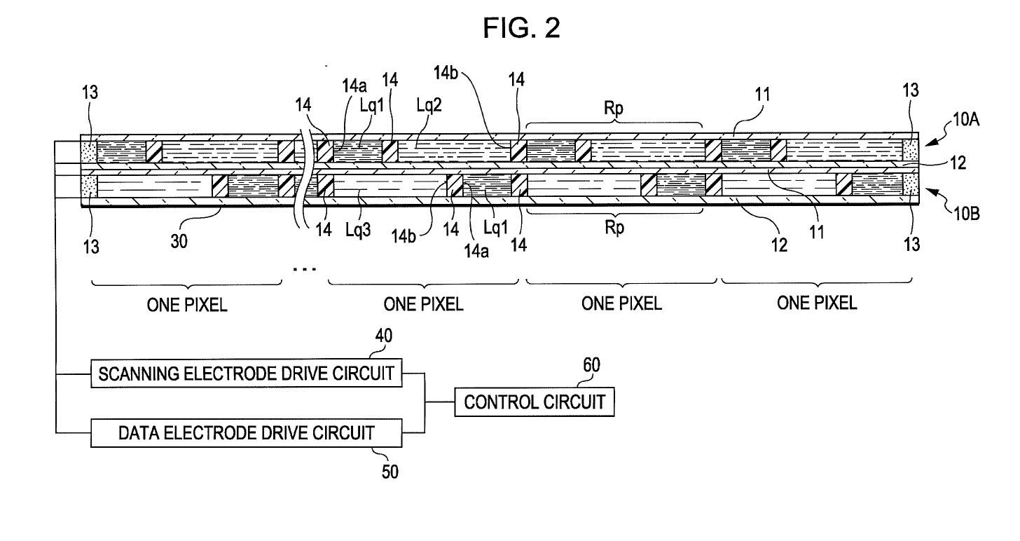

FIG. 1 is a schematic view of a liquid crystal display device according to a first embodiment. FIG. 2 is a cross sectional view of the liquid crystal display device according to the first embodiment.

As illustrated in FIGS. 1 and 2, a liquid crystal display device has a first liquid crystal display element 10A, a second liquid crystal display element 10B, a visible light absorption layer 30, a scanning electrode drive circuit 40, a data electrode drive circuit 50, and a control circuit 60. As the liquid crystal display device, electronic paper is assumed, for example but the invention is not limited thereto and other liquid crystal display devices may be employed.

The first and second liquid crystal display elements 10A and 10B are laminated on each other to constitute one liquid crystal display panel. The first and second liquid crystal display elements 10A and 10B each has the same number of pixel regions Rp inside seal members 13 (described later). The pixel regions Rp of the first liquid crystal display element 10A and the pixel regions Rp of the second liquid crystal display element 10B face each other to constitute one pixel of the liquid crystal display panel. The first liquid crystal display element 10A is disposed at the front side of the liquid crystal display panel, i.e., at the side of a display surface of various kinds of information, and the second liquid crystal display element 10B is disposed at the back side of the liquid crystal display panel, i.e., at the side opposite to the display surface of various kinds of information.

The visible light absorption layer 30 is disposed at the back side of the second liquid crystal display element 10B as required. Materials of the visible light absorption layer 30 are not particularly limited and black materials which can absorb at least visible light (wavelength band: 360 nm to 830 nm) are used. Therefore, visible light penetrating the first and second liquid crystal display elements 10A and 10B is absorbed into the visible light absorption layer 30 and the light is not reflected by the front side of the liquid crystal display panel on which the first and second liquid crystal display elements 10A and 10B are disposed.

The scanning electrode drive circuit 40 is connected to scanning electrodes 11a and 11a (described later) of the first and second liquid crystal display elements 10A and 10B and applies a drive voltage to these scanning electrodes 11a and 11a. The data electrode drive circuit 50 is connected to data electrodes 12a and 12a (described later) of the first and second liquid crystal display elements 10A and 10B and applies a drive voltage to these data electrodes 12a and 12a. The scanning electrode drive circuit 40 according to this embodiment is connected to both of the scanning electrodes 11a and 11a of the first and second liquid crystal display elements 10A and 10B and the data electrode drive circuit 50 is connected to both of the data electrodes 12a and 12a of the first and second liquid crystal display elements 10A and 10B. However, the invention is not limited thereto. For example, separate scanning electrode drive circuits 40 and 40 and separate data electrode drive circuits 50 and 50 may be connected to each of the first and second liquid crystal display elements 10A and 10B. In this case, the thickness of the liquid crystal display panel can be reduced by arranging the circuits in such a manner that the circuits are not superimposed on each other by shifting the arrangement of the scanning electrode drive circuits 40 and 40 and the data electrode drive circuits 50 and 50.

The control circuit 60 is connected to the scanning electrode drive circuit 40 and the data electrode drive circuit 50. The control circuit 60 controls the scanning electrode drive circuit 40 and the data electrode drive circuit 50 to let the circuits apply a drive voltage to the scanning electrodes 11a and 11a and the data electrodes 12a and 12a of the first and second liquid crystal display elements 10A and 10B.

Configuration of First and Second Liquid Crystal Display Elements 10A and 10B

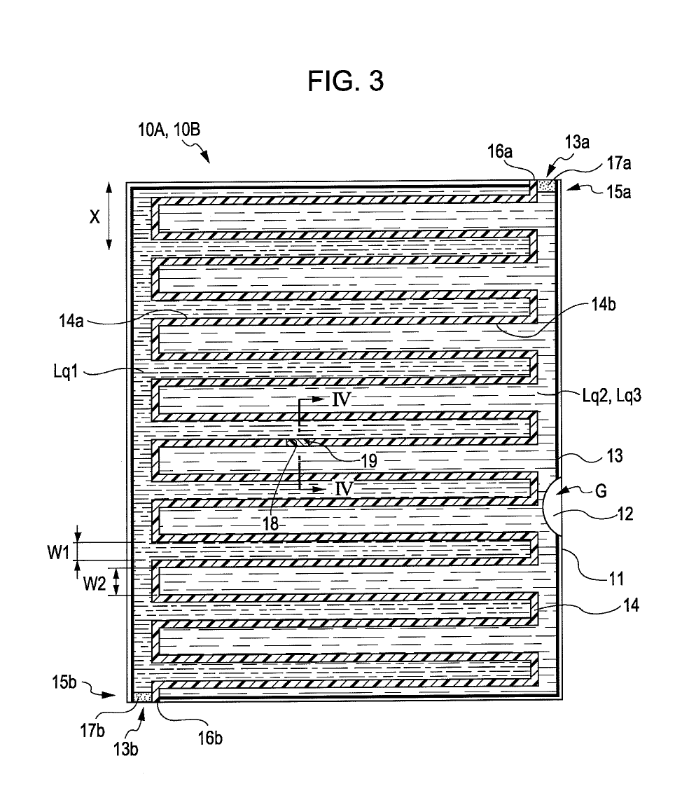

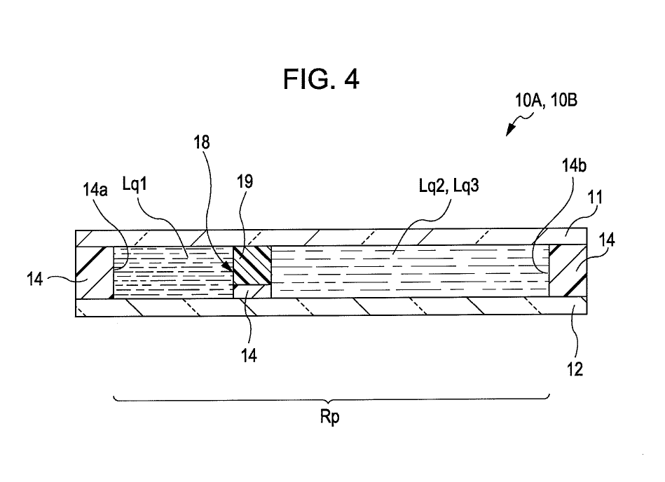

FIG. 3 is a plan view of the first and second liquid crystal display elements 10A and 10B according to the first embodiment. FIG. 4 is a partial cross-sectional view of the first and second liquid crystal display elements 10A and 10B according to the first embodiment and illustrates the cross section along the IV-IV line of FIG. 3.

The first and second liquid crystal display elements 10A and 10B fundamentally have the same configuration, except for the type of the liquid crystal materials injected into first and second spaces 14a and 14b (described later). Therefore, in this description, the configuration of the first liquid crystal display element 10A will be described in detail and differences of the first liquid crystal display element 10A from the second liquid crystal display element 10B will be complementarily described.

As illustrated in FIG. 3, the first liquid crystal display element 10A has a first substrate 11 and a second substrate 12 facing each other and a seal member 13 which is disposed between the first and second substrates 11 and 12 and seals the gap between the first and second substrates 11 and 12, and a wall portion (structure) 14 disposed between the first and second substrate 11 and 12. The ratio of the dimension of the first and second substrates 11 and 12 and the dimension of the wall portion 14 illustrated in FIG. 3 is different from the actual dimension of the first liquid crystal display element 10A.

The first and second substrates 11 and 12 each are formed in a rectangular shape and a gap G for storing first and second liquid crystal materials Lq1 and Lq2 (described later) is formed between the first and second substrates 11 and 12. The dimension of the gap G between the first and second substrates 11 and 12, i.e., the interval between the first and second substrates 11 and 12, is not particularly limited and may be 1 μm to 10 μm, for example. In this embodiment, the dimension of the gap G between the first and second substrates 11 and 12 is about 5 μm. Materials of the first and second substrates 11 and 12 are not particularly limited. For example, resin materials, such as Poly Ethylene Terephthalate (PET), Poly Carbonate (PC), Poly Ethylene Naphthalate (PEN), and Poly Ether Sulfone (PES) or glass materials may be used. The thickness of the first and second substrates 11 and 12 is not particularly limited and is about 100 μm in this embodiment.

The first substrate 11 is disposed at the front side of the liquid crystal display panel in the first liquid crystal display element 10A and a plurality of scanning electrodes 11a are disposed at the inner surface facing the second substrate 12 (FIG. 1). The plurality of scanning electrodes 11a mutually extend in parallel to each other at intervals and the scanning electrode drive circuit 40 is connected to each of the scanning electrodes 11a. As materials of the scanning electrodes 11a, metal oxides having transparency, such as indium tin oxide (ITO), or other metal containing substances may be used, for example.

The second substrate 12 is disposed on the back side of the liquid crystal display panel in the first liquid crystal display element 10A and a plurality of data electrodes 12a are disposed at the inner surface facing the first substrate 11 (FIG. 1). The plurality of data electrodes 12a mutually extend in parallel to each other at intervals and the data electrode drive circuit 50 is connected to each of the data electrodes 12a. As materials of the data electrodes 12a, metal oxides having transparency, such as indium tin oxide (ITO), or other metal containing substances may be used, for example.

The data electrodes 12a and the scanning electrodes 11a mutually cross and the first and second liquid crystal materials Lq1 and Lq2 (described later) are sandwiched between the scanning electrodes 11a and the data electrodes 12a. Therefore, when a drive voltage is applied to the scanning electrodes 11a and the data electrodes 12a, a control voltage is applied to the first and second liquid crystal materials Lq1 and Lq2 located between the scanning electrodes 11a and the data electrodes 12a, so that the arrangement of the liquid crystal molecules of the first and second liquid crystal materials Lq1 and Lq2 is changed as appropriate.

An orientation film (not illustrated) for controlling the arrangement of the liquid crystal molecules is formed on the inner surface of the first substrate 11 in such a manner as to cover the scanning electrodes 11a. Similarly, an orientation film (not illustrated) for controlling the arrangement of the liquid crystal molecules is formed on the inner surface of the second substrate 12 in such a manner as to cover the data electrodes 12a. As materials of the orientation film, polyimide resin may be used, for example.

The seal members 13 are disposed between the first and second substrates 11 and 12 and seal the gap G between the first and second substrates 11 and 12 in a fluid-tight manner. The seal members 13 extend in parallel to the edge of the first and second substrates 11 and 12 near the edge of the first and second substrates 11 and 12. At a first corner portion 15a and a second corner portion 15b facing each other among four corner portions of the liquid crystal display panel, seal missing portions 13a and 13b in which the seal members 13 do not exist are disposed. The seal missing portions 13a and 13b according to this embodiment are disposed at the first and second corner portions 15a and 15b facing each other of the liquid crystal display panel but the invention is not limited thereto. More specifically, the seal missing portions 13a and 13b may be disposed at any portion of the liquid crystal display panel. Materials of the seal members 13 are not particularly limited and acrylic resin materials may be used, for example.

The wall portion 14 is disposed between the first and second substrates 11 and 12 and extends in a meandering manner from the first corner portion 15a to the second corner portion 15b of the liquid crystal display panel. Thus, the wall portion 14 defines comb-shaped first and second spaces 14a and 14b which mutually engage in the gap G between the first and second substrates 11 and 12. Materials of the wall portion 14 are not particularly limited and photosensitive resin, such as acrylic resist materials, may be used, for example. The width of the wall portion 14 is not particularly limited and is controlled to about 10 μm in this embodiment.

The wall portion 14 adheres to the inner surface of both of the first and second substrates 11 and 12 and isolates the first and second space 14a and 14b in a fluid-tight manner. Into the first and second spaces 14a and 14b, mutually different kinds of liquid crystal materials, i.e., the first liquid crystal material Lq1 and the second liquid crystal material Lq2, are injected. Both the ends of the wall portion 14 reach the edge of the first and second substrates 11 and 12 and individually cooperate with the seal members 13 to define a first injection port 16a of the first liquid crystal material Lq1 and a second injection port 16b of the second liquid crystal material Lq2. More specifically, the first space 14a and the second space 14b has the first injection port 16a of the first liquid crystal material Lq1 and the second injection port 16b of the second liquid crystal material Lq2, respectively, at the position corresponding to each of the first and second corner portions 15a and 15b of the liquid crystal display panel.

The first and second injection ports 16a and 16b are sealed by sealing members 17a and 17b, respectively, and thus the outflow of the first and second liquid crystal materials Lq1 and Lq2 from the first and second spaces 14a and 14b. Materials of the sealing members 17a and 17b are not particularly limited and epoxy resin may be used, for example.

A width dimension W1 of the first space 14a in the arrangement direction (the direction indicated by the arrow X in FIG. 3) of the first and second spaces 14a and 14b is controlled to be about half of a width dimension W2 of the second space 14b. Therefore, as illustrated in FIG. 4, the occupied area of the first liquid crystal material Lq1 in the pixel regions Rp of the first and second liquid crystal display elements 10A and 10B is about half of the occupied area of the second liquid crystal material Lq2. However, the width dimensions W1 and W2 of each of the first and second spaces 14a and 14b are not limited thereto.

Into the above-described first and second spaces 14a and 14b, the first liquid crystal material Lq1 and the second liquid crystal material Lq2 are injected, respectively. As the first and second liquid crystal materials Lq1 and Lq2, a cholesteric liquid crystal is used, for example. The cholesteric liquid crystal (chiral nematic liquid crystal) is one in which a chiral additive agent (a chiral material) is added to a nematic liquid crystal and has a feature such that each of the liquid crystal molecules is stabilized in an orientation state of a planar state in which incidence light is reflected or a focal conic state in which incidence light is transmitted. As the first and second liquid crystal materials Lq1 and Lq2 according to this embodiment, liquid crystal materials that are different from each other among three kinds of liquid crystal materials that reflect the wavelengths of the bands of red (R), blue (B), and green (G).

The wall portion 14 is very fine, and therefore a defect 18 often arises. The defect 18 makes the first and second spaces 14a and 14b communicate, which causes mixing of the first and second liquid crystal materials Lq1 and Lq2. However, in this embodiment, a cured body 19 containing a substance obtained by curing photo-curable resin is filled in the defect 18 arising in the wall portion 14. More specifically, the defect 18 arising in the wall portion 14 is blockaded with the cured body 19 of a UV curable liquid crystal. Thus, the first and second spaces 14a and 14b are separated in a fluid-tight manner, and therefore the mixing of the first and second liquid crystal materials Lq1 and Lq2 is prevented. As described later, the photo-curable resin is to be mixed with the first and second liquid crystal materials Lq1 and Lq2. As the photo-curable resin, a UV curable liquid crystal may be used, for example. The UV curable liquid crystal is a liquid crystal material in which each liquid crystal molecule has a side chain and which has ultraviolet curing properties as a whole. Mentioned as a specific example of the UV curable liquid crystal are UCL-001 and UCL-002 available from Dainippon Ink & Chemicals, Inc. (DIC) and the like are mentioned, for example.

The cured body 19 according to this embodiment may be in a focal conic state, a planar state, a homeotropic state, or another state. The first and second liquid crystal materials Lq1 and Lq2 may contain an uncured UV curable liquid crystal. The proportion of the uncured UV curable liquid crystal occupying the entire first and second liquid crystal materials Lq1 and Lq2 is preferably lower than 10% by weight, for example. When the proportion of the uncured UV curable liquid crystal is lower than 10% by weight, the display quality of the liquid crystal display panel is hardly influenced even when the first and second liquid crystal materials Lq1 and Lq2 are irradiated with ultraviolet rays after the completion of the liquid crystal display panel.

Next, differences of the second liquid crystal display element 10B from the first liquid crystal display element 10A will be described.

As illustrated in FIG. 2, the second liquid crystal display element 10B is one in which the back and the front of the first liquid crystal display element 10A are reversed. Therefore, the arrangement of the first and second spaces 14a and 14b of the second liquid crystal display element 10B is in reverse to the arrangement of the first and second spaces 14a and 14b of the first liquid crystal display element 10A. More specifically, the first space 14a of the first liquid crystal display element 10A is located at the left side in FIG. 2 of the pixel region Rp but the first space 14a of the second liquid crystal display element 10B is located at the right side of FIG. 2 of the pixel region Rp.

Into the above-described first and second spaces 14a and 14b of the second liquid crystal display element 10B, the first liquid crystal material Lq1 and a third liquid crystal material Lq3 are injected, respectively. More specifically, into the first space 14a of the second liquid crystal display element 10B and the first space 14a of the first liquid crystal display element 10A, a common liquid crystal material, i.e., the first liquid crystal material Lq1 is injected but, into the second space 14b of the second liquid crystal display element 10B, the third liquid crystal material Lq3 is injected which is different from the second liquid crystal material Lq2 injected into the second space 14b of the first liquid crystal display element 10A. As the third liquid crystal material Lq3, a liquid crystal material different from the first and second liquid crystal materials Lq1 and Lq2 among three kinds of liquid crystal materials which reflect the wavelengths of the bands of red (R), blue (B), and green (G).

Therefore, when focusing attention on one pixel of the liquid crystal display panel constituted by the pixel regions Rp of the first liquid crystal display element 10A and the pixel regions Rp of the second liquid crystal display element 10B, the occupied area of each of the first, second, and third liquid crystal materials Lq1, Lq2, and Lq3 is equivalent.

Manufacturing Processes of First and Second Liquid Crystal Display Elements 10A and 10B

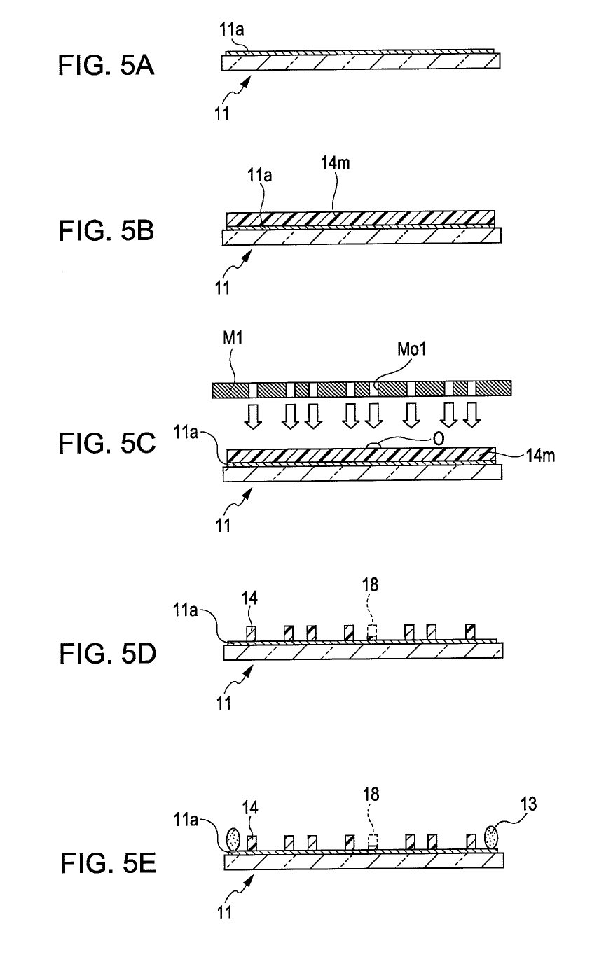

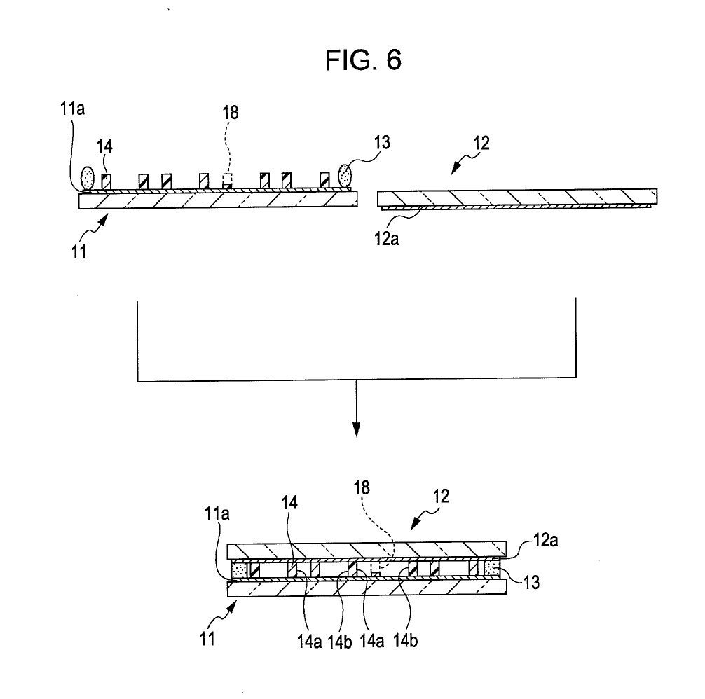

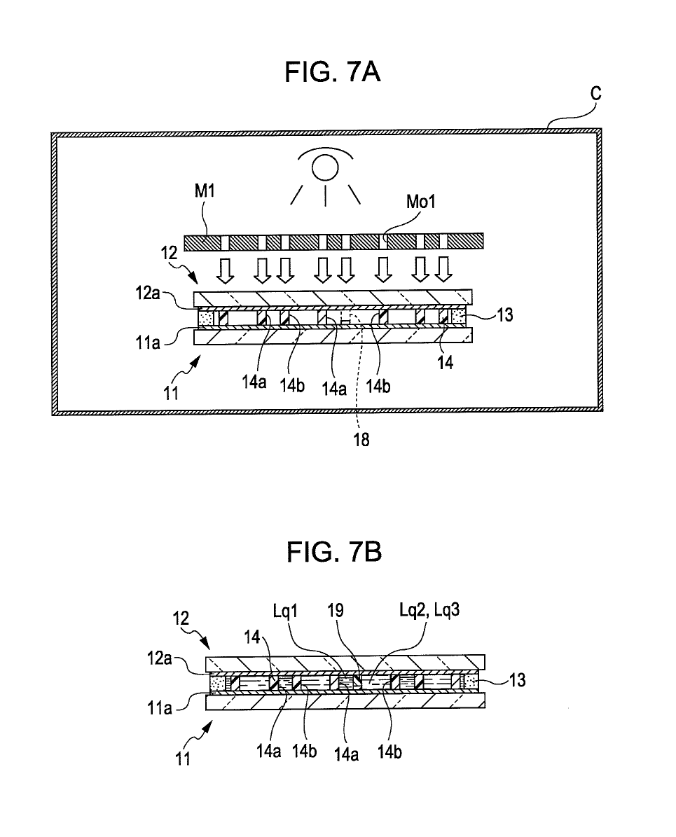

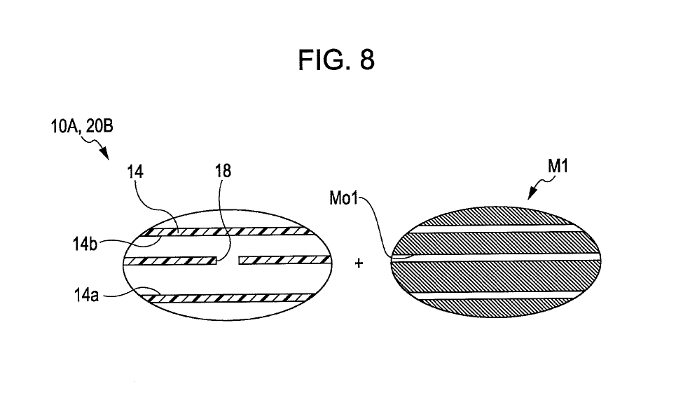

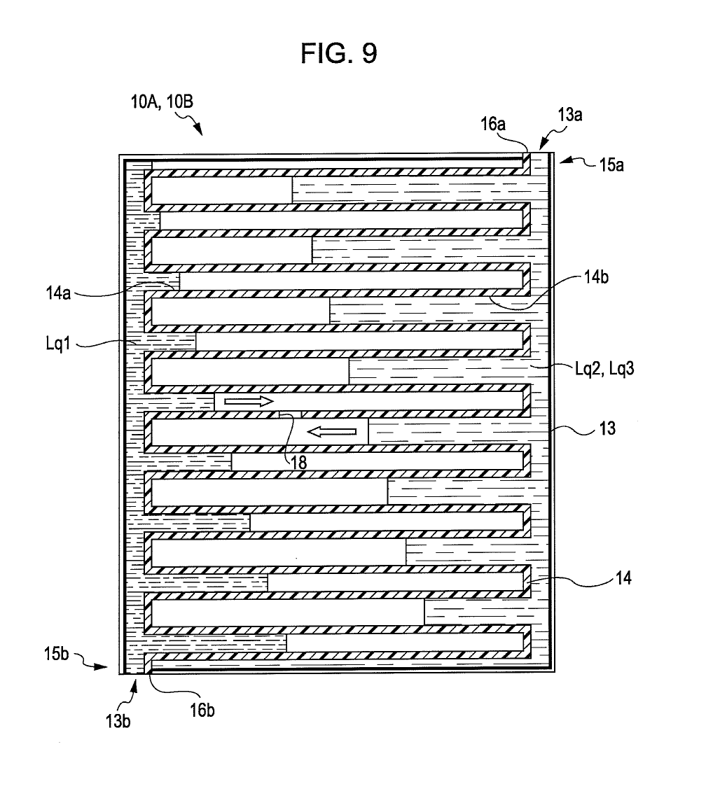

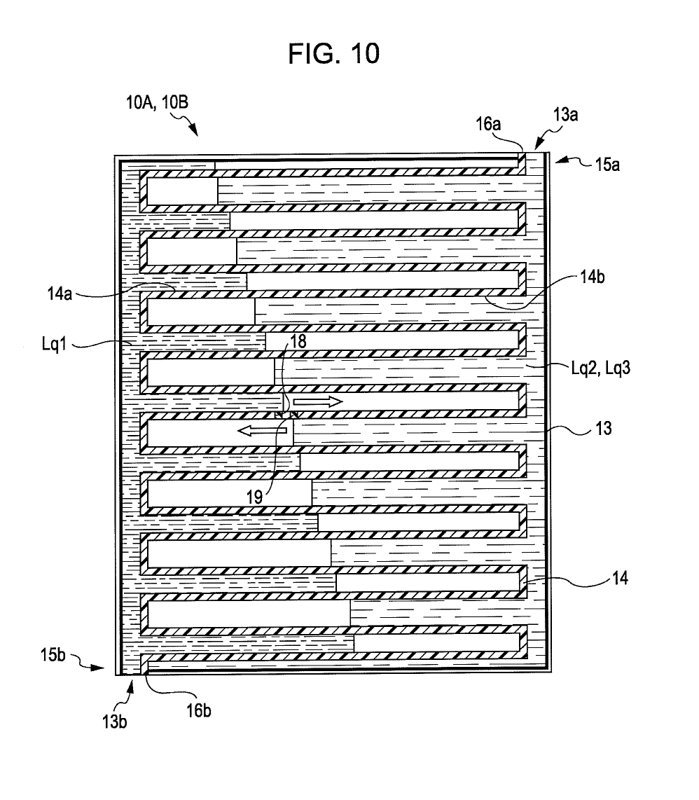

FIGS. 5A to 5E are views illustrating manufacturing processes of the first and second liquid crystal display elements according to the first embodiment. FIG. 6 illustrates a manufacturing process of the first and second liquid crystal display element according to the first embodiment. FIGS. 7A and 7B are views illustrating manufacturing processes of the first and second liquid crystal display elements according to the first embodiment. FIG. 8 is a view illustrating the relationship between the wall portion of the first and second liquid crystal display element according to the first embodiment and the opening of a photomask. FIG. 9 is a view illustrating an injection process of the first and second liquid crystal materials according to the first embodiment. FIG. 10 is a view illustrating the injection process of the first and second liquid crystal materials according to the first embodiment.

As illustrated in FIG. 5A, first, a plurality of scanning electrodes 11a are formed on the first substrate 11. The formation method of the scanning electrodes 11a is not particularly limited. For example, a metal film of indium oxide or the like is vapor-deposited on the first substrate 11, and then the metal film may be patterned by etching.

Next, as illustrated in FIG. 5B, an acrylic resist material, for example, is applied onto the first substrate 11, and then the resist material is cured by heating to thereby form a photosensitive resist film (photosensitive film) 14m having a thickness of about 5 μm. The application method is not particularly limited and spin coating may be used, for example. The heating temperature or the heating time is not particularly limited and may be selected as appropriate in accordance with the resist material. Before the formation of the resist film 14m, an orientation film (not illustrated) covering the plurality of scanning electrodes 11a may be formed on the first substrate 11.

Next, as illustrated in FIG. 5C, a resist film 14m formed on the first substrate 11 is exposed using a photomask (exposure mask) M1. For the photomask M1, one obtained by forming a shading film (not illustrated) of chromium (Cr) or the like is formed on the surface of a quartz plate may be used, for example. The shading film has an opening Mo1 having the shape of the wall portion 14, i.e. extending in a meandering manner. Therefore, when the resist film 14m is exposed using the photomask M1, the resist film 14m is irradiated with light penetrating the opening Mo1 extending in a meandering manner to thereby form a zigzag-shaped exposure pattern corresponding to the wall portion 14 on the resist film 14m. When shading substances, such as particles, exist on the resist film 14m, for example, at this time, the resist film 14m is not sufficiently exposed in some cases. The dimension of the opening Mo1 of the photomask M1 may be determined in accordance with the interval between the photomask M1 and the resist film 14m, i.e., a print gap.

Next, as illustrated in FIG. 5D, a developer is supplied onto the resist film 14m, and an unexposed portion of the resist film 14m is removed. Thus, the wall portion 14 corresponding to the exposure pattern, i.e., corresponding to the opening Mo1 of the photomask M1, is formed on the first substrate 11. However, when a shading substance O exists on the resist film 14m in exposing the resist film 14m, the resist film 14m located under the shading substance O is not sufficiently exposed in some cases. Therefore, the resist film 14m located under the shading substance O is removed from the first substrate 11 as an unexposed portion in supplying the developer, sometimes resulting in the generation of the defect 18 in the wall portion 14.

Next, as illustrated in FIG. 5E, the seal members 13 in parallel to the edge of the first substrate 11 are formed at the edge of the first substrate 11. When the gap G between the first and second substrates 11 and 12 is about 5 μm, the height of the seal members 13 is controlled to be higher than 5 μm. As the formation method of the seal members 13, a dispense method may be used.

Next, as illustrated in FIG. 6, a second substrate 12 is mounted on the seal members 13 and the wall portion 14 formed on the first substrate 11. The second substrate 11 is separately prepared, on which a plurality of data electrodes 12a are formed. The formation method of the plurality of data electrodes 12a may be equivalent to that of the plurality of scanning electrodes 11a. Subsequently, the first and second substrates 11 and 12 are bonded to each other by heating and pressurizing the first and second substrates 11 and 12 to define the first spaces 14a and the second spaces 14b mutually isolated in the gap G between the first and second substrates 11 and 12. When the defect 18 exists in the wall portion 13, the first and second spaces 14a and 14b communicate through the defect 18. Before bonding the first and second substrates 11 and 12 to each other, a plurality of spherical spacers (not illustrated) may be dispersed onto either one of the first and second substrate 11 and 12. When the plurality of spherical spacers are dispersed, the gap G between the first and second substrates 11 and 12 is difficult to change when bending the first liquid crystal display element 10A. Therefore, a considerable flow of the first and second liquid crystal materials Lq1 and Lq2 injected into the first and second spaces 14a and 14b can be prevented. Furthermore, before bonding the first and second substrates 11 and 12 to each other, a columnar spacer (not illustrated) having adhesiveness may be disposed on either one of the first and second substrate 11 and 12. When the columnar spacer is disposed, the first and second substrates 11 and 12 are made to adhere to the columnar spacer. Therefore, the first and second substrates 11 and 12 can be firmly bonded to each other.

Next, as illustrated in FIG. 7A, the laminate of the first and second substrates 11 and 12 is disposed in a chamber C. Subsequently, the inside of the chamber C is decompressed to form a vacuum state. Subsequently, as illustrated in FIG. 8, the laminate of the first and second substrates 11 and 12 is irradiated with ultraviolet rays using the photomask M1 for use in exposing the resist film 14m. Thus, ultraviolet rays are selectively emitted to a region equivalent to the exposure pattern formed on the resist film 14m, i.e., a region where the wall portion 14 is to be formed. When the defect 18 arises in the wall portion 14, ultraviolet rays are also emitted to the defect 18. More specifically, the use of the photomask M1 allows selective emission of ultraviolet rays to the boundary portion between the first and second spaces 14a and 14b. The wavelength of the ultraviolet rays is not particularly limited and may be 254 nm or more, for example. Furthermore, the wavelength may be equal to or higher than a wavelength exceeding the wavelength of the band of ultraviolet rays, e.g., 365 nm. When the wavelength of 365 nm or more is used, a breakage of the liquid crystal materials can be suppressed. Then, during the irradiation with ultraviolet rays, the first and second injection ports 16a and 16b are immersed in the first and second liquid crystal materials Lq1 and Lq2 stored in a liquid crystal bath, respectively, and the inside of the chamber C is opened to the atmospheric pressure. Thus, the first and second liquid crystal materials Lq1 and Lq2 in the liquid crystal bath are pressurized by the atmospheric pressure, and are gradually diffused into the first and second spaces 14a and 14b as illustrated in FIG. 9. The first and second liquid crystal materials Lq1 and Lq2 contain a photo-curable resin. As the photo-curable resin, a UV curable liquid crystal may be used, for example. The UV curable liquid crystal is a liquid crystal material in which each of the liquid crystal molecules has a side chain and which has ultraviolet curing properties as a whole. Mentioned as a specific example of the UV curable liquid crystal are UCL-001 and UCL-002 available from Dainippon Ink & Chemicals, Inc. (DIC) and the like, for example. As illustrated in FIG. 10, when the first liquid crystal material Lq1 or the second liquid crystal material Lq2 reaches the defect 18, the first liquid crystal material Lq1 or the second liquid crystal material Lq2 is exposed to the ultraviolet rays emitted to the defect 18. Thus, the UV curable liquid crystal in the first liquid crystal material Lq1 or the second liquid crystal material Lq2 is cured to thereby form a cured body 19 in the defect 18. As described above, in this embodiment, since the laminate of the first and second substrates 11 and 12 is irradiated with ultraviolet rays using the photomask M1 for use in exposing the resist film 14m, there is no necessity of locally emitting ultraviolet rays targeting the defect 18. Therefore, in order to fill the cured body 19 in the defect 18, there is no necessity of adding a complicated procedure.

When determining the proportion of the UV curable liquid crystal occupying the first and second liquid crystal materials Lq1 and Lq2, the number and the average volume of the defect 18 contained in one first liquid crystal display element 10A are first calculated, and then the total volume of the defect 18 contained in the first liquid crystal display element 10A is estimated based on the number and the average volume of the defect 18. Then, the proportion of the UV curable liquid crystal with which the total volume of the defect 18 can be sufficiently filled is determined. For example, the proportion of the UV curable liquid crystal may be determined based on the proportion of the wall portion 14 occupying the first liquid crystal display element 10A and the probability that the UV curable liquid crystal exists near the wall portion 14. Specifically, when the length of one pixel is 150 μm and the width of the wall portion 14 is 10 μm, the proportion of the wall portion 14 occupying the first liquid crystal display element 10A is about 15%. Therefore, when the probability that the UV curable liquid crystal exists near the wall portion 14 is controlled to be 50%, the proportion of the UV curable liquid crystal may be 5% to 15% and more preferably 7% to 10%.

Next, when the first and second spaces 14a and 14b are charged with the first and second liquid crystal materials Lq1 and Lq2 as illustrated in FIG. 7B, sealing members 17a and 17b are injected into the first and second injection ports 16a and 16b to completely seal the first and second spaces 14a and 14b. As the injection method of the sealing members 17a and 17b, the first and second injection ports 16a and 16b may be charged with epoxy resin having fluidity, for example, and then the epoxy resin may be heated and cured by a heating head or the like.

Through the above-described processes, the first liquid crystal display element 10A is completed. A manufacturing process of the second liquid crystal display element 10B is also equivalent to that of the first liquid crystal display element 10A.

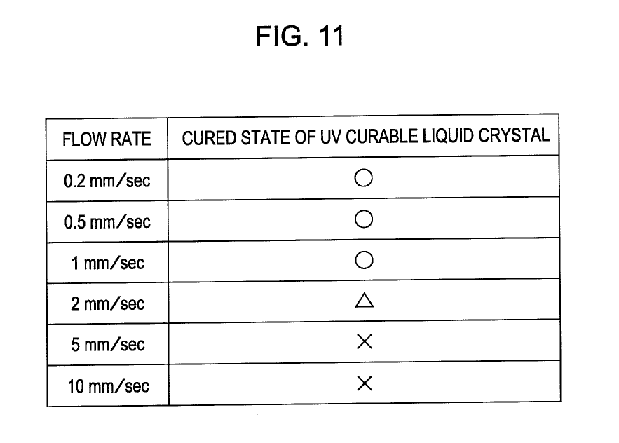

FIG. 11 illustrates the results of an experiment of curing the UV curable liquid crystal with ultraviolet rays and illustrates the relationship between the flow rate of a liquid crystal material containing the UV curable liquid crystal with the proportion equivalent to that of the first and second liquid crystal materials Lq1 and Lq2 according to the first embodiment and a cured state of the UV curable liquid crystal. In the experiment, the irradiation dose of ultraviolet rays is 500 mJ/cm2 and the proportion of the UV curable liquid crystals in the first and second liquid crystal materials Lq1 and Lq2 is 10% by weight.

As illustrated in FIG. 11, it is found that when the flow rate of the liquid crystal material is 2 mm/sec or more, the liquid crystal material is not sufficiently cured, but when the flow rate of the liquid crystal material is 1 mm/sec or lower, the liquid crystal material is sufficiently cured. Therefore, when the flow rate of the first and second liquid crystal materials Lq1 and Lq2 is controlled to be 1 mm/sec or lower in injecting the first and second liquid crystal materials Lq1 and Lq2 into the first liquid crystal display element 10A, the UV curable liquid crystal contained in the first or second liquid crystal material Lq1 or Lq2 that reaches the defect 18 is sufficiently cured, and therefore the defect 18 can be sealed in a fluid-tight manner. The flow rate of the first and second liquid crystal materials Lq1 and Lq2 according to this embodiment need not to be always 1 mm/sec or lower. More specifically, the flow rate of the first and second liquid crystal materials Lq1 and Lq2 may be determined in accordance with the irradiation dose of ultraviolet rays or the proportion of the UV curable liquid crystal occupying the first and second liquid crystal materials Lq1 and Lq2.

In the first embodiment, both of the first and second liquid crystal material Lq1s and Lq2 contain the UV curable liquid crystal. However, this embodiment is not limited thereto and, for example, the UV curable liquid crystal may be blended in only either one of the first and second liquid crystal materials Lq1 and Lq2. When the UV curable liquid crystal may be blended in only either one of the first and second liquid crystal materials Lq1 and Lq2, the liquid crystal material in which the UV curable liquid crystal is blended among the first and second liquid crystal materials Lq1 and Lqw2 needs to first reach the defect 18 of the wall portion 14. Therefore, the first and second liquid crystal materials Lq1 and Lq2 are not simultaneously injected into the first and second spaces 14a and 14b, but the liquid crystal material in which the UV curable liquid crystal is blended among the first and second liquid crystal materials Lq1 and Lq2 should be injected first.

The first and second liquid crystal materials Lq1 and Lq2 according to the first embodiment contain the UV curable liquid crystal but the invention is not limited thereto. For example, another ultraviolet curable resin may be used insofar as a material that is cured by irradiation with ultraviolet rays is sed. Furthermore, not a material that is cured by irradiation with ultraviolet rays but a thermosetting resin that is cured by heating may be used.

### Second Embodiment

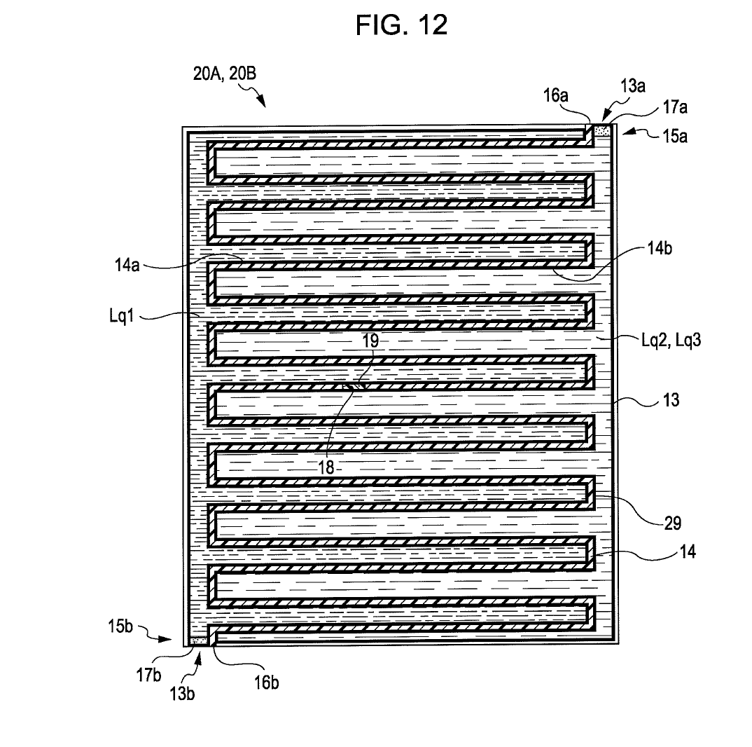

Next, a second embodiment will be described with reference to FIGS. 12 to 14.

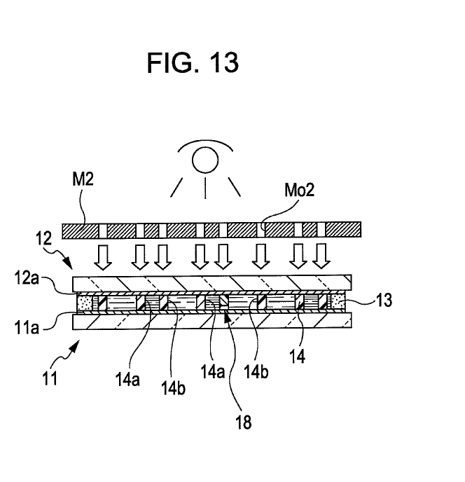

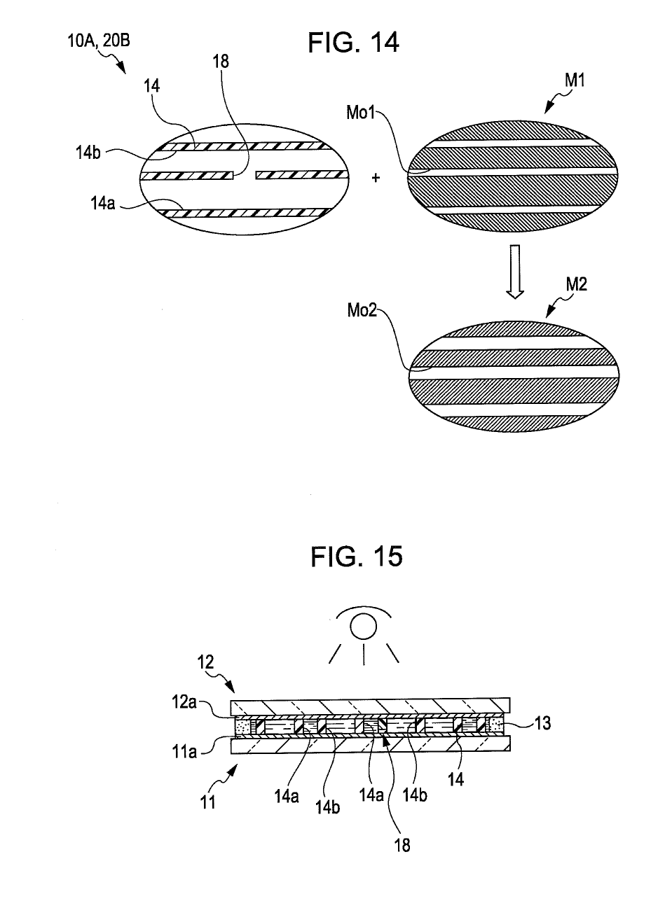

FIG. 12 is a plan view illustrating first and second liquid crystal display elements according to the second embodiment. FIG. 13 is a view illustrating a manufacturing process of the first and second liquid crystal display elements according to the second embodiment. FIG. 14 illustrates a wall portion of the first and second liquid crystal display elements according to the second embodiment and an opening of a photomask.

The first and second liquid crystal materials Lq1 and Lq2 each according to the first embodiment contain an uncured UV curable liquid crystal. Therefore, when ultraviolet rays are emitted after the completion of the first and second liquid crystal display elements 10A and 10B, the uncured UV curable liquid crystal of the first and second liquid crystal materials Lq1 is cured in some cases. In this case, when the liquid crystal to which the UV curable liquid crystal is added is in a focal conic state, the cured body to be generated is also in a focal conic state. Therefore, the contrast of the first and second liquid crystal display elements 10A and 10B increases. When the liquid crystal to which the UV curable liquid crystal is added is in a planar state, the cured body to be generated is also in a planar state. Therefore, the brightness of the first and second liquid crystal display elements 10A and 10B increases. More specifically, when an uncured UV curable liquid crystal remains, the brightness or the contrast of the first and second liquid crystal display elements 10A and 10B varies in some cases after the completion of the first and second liquid crystal display elements 10A and 10B.

However, as illustrated in FIG. 12, in first and second liquid crystal display elements 20A and 20B according to the second embodiment, the uncured UV curable liquid crystal is deposited to the inner surface of the wall portion 14 to form a cured body 29. Therefore, the brightness or the contrast of the first and second liquid crystal display elements 20A and 20B do not vary after the completion of the first and second liquid crystal display elements 20A and 20B.

Therefore, in the second embodiment, after sealing the first and second injection ports 16a and 16b with the sealing members 17a and 17b, the first and second liquid crystal display elements 20A and 20B are irradiated with ultraviolet rays using a ultraviolet exposure photomask (curing mask) M2 as illustrated in FIG. 13.

The ultraviolet exposure photomask M2 used here has an opening Mo2 broader than the opening Mo1 of the photomask M1 as illustrated in FIG. 14. Therefore, when the first and second liquid crystal display elements 20A and 20B are irradiated with ultraviolet rays using the photomask M2, ultraviolet rays can be emitted to not only the wall portion 14 (including the defect 18) but the vicinity of the side surface of the wall portion 14.

Therefore, when the UV curable liquid crystal comes closer to the side surface of the wall portion 14 in associated with the thermal agitation of the liquid crystal molecules of the first and second liquid crystal materials Lq1 and Lq2, the UV curable liquid crystal is exposed to the ultraviolet rays emitted to the vicinity of the side surface of the wall portion 14, so that the UV curable liquid crystal is deposited as the cured body 29 to the inner surface of the wall portion 14. Thus, the first and second liquid crystal materials Lq1 and Lq2 according to the second embodiment are isolated by the wall portion 14 and the cured body 29 deposited to the inner surface of the wall portion 14.

The dimension of the opening Mo2 of the photomask M2 may be determined in accordance with the interval of the photomask M2 and the first and second liquid crystal display elements 20A and 20B, i.e., a print gap. For example, the dimension may be determined in such a manner that, for example, when ultraviolet rays are emitted using the photomask M2, ultraviolet rays are emitted to a region in the range of about 2 to 3 μm from the side surface of the wall portion 14. The photomask M2 can be relatively easily manufactured when the mask data of the photomask M1 is used. Therefore, the manufacturing cost of the photomask M2 does not become problematic.

The wavelength of the ultraviolet rays is not particularly limited and may be equivalent to the ultraviolet rays used in order to form the cured body 19, i.e., 254 nm or more. The wavelength of the ultraviolet rays may be equal to or higher than a wavelength exceeding the band of ultraviolet rays, e.g., 365 nm. When the wavelength of 365 nm or more is used, a breakage of the liquid crystal materials can be suppressed.

The cured body 29 may be in any one of a focal conic state, a planar state, and a homeotropic state or in another state. In order to increase the brightness of the first and second liquid crystal display elements 20A and 20B, the cured body 29 may be positively set to a planar state. In order to increase the contrast of the first and second liquid crystal display elements 20A and 20B, the cured body 29 may be positively set to a focal conic state. In order to set the state of the cured body 29 to a planar state or a focal conic state, ultraviolet rays may be emitted to the vicinity of the wall portion 14 by, for example, applying a drive voltage to the scanning electrodes 11a and the data electrodes 12a by a testing machine (not illustrated) to set the state of the liquid crystal material to which an uncured UV curable liquid crystal is added to a planar state or a focal conic state.

As described above, the first and second liquid crystal materials Lq1 and Lq2 according to the second embodiment do not contain an uncured UV curable liquid crystal, and therefore the brightness or the contrast of the first and second liquid crystal display elements 20A and 20B do not vary after the completion of the first and second liquid crystal display elements 20A and 20B.

### Modification of Second Embodiment

Next, a modification of the second embodiment will be described with reference to FIG. 15.

FIG. 15 is a view illustrating a manufacturing process of first and second liquid crystal display element according to the modification of the second embodiment.

In the second embodiment, the first and second liquid crystal display elements 20A and 20B are irradiated with ultraviolet rays after injecting the first and second liquid crystal materials Lq1 and Lq2 using the photomask M2. However, the invention is not limited thereto. For example, as illustrated in FIG. 15, ultraviolet rays may be emitted to the entire surface of the first and second liquid crystal display elements 20A and 20B. In a cured body, UV curable liquid crystal molecules which are macromolecules are connected to each other, and therefore the fluidity is lost. However the first and second liquid crystal materials Lq1 and Lq2 which exist between the UV curable liquid crystal molecules can take an orientation state corresponding to a drive voltage applied from the outside. Therefore, even when the entire surface of the first and second liquid crystal display elements 20A and 20B is irradiated with ultraviolet rays to cure the UV curable liquid crystals, the drive of the first and second liquid crystal display elements 10A and 10B is not affected.

The wavelength of the ultraviolet rays is not particularly limited and may be equivalent to that of the ultraviolet rays used in order to form the cured body 19, i.e., 254 nm or more. The wavelength may be equal to or higher than a wavelength exceeding the wavelength of the band of ultraviolet rays, e.g., 365 nm. When the wavelength of 365 nm or more is used, a breakage of the liquid crystal materials can be suppressed.

A cured body (not illustrated) may be in any one of a focal conic state, a planar state, a homeotropic state, or in another state. In order to increase the brightness of the first and second liquid crystal display elements 20A and 20B, the cured body may be positively set to a planar state. In order to increase the contrast of the first and second liquid crystal display elements 20A and 20B, the cured body may be positively set to a focal conic state.

As described above, when the entire surface of the first and second liquid crystal display elements 20A and 20B is irradiated with ultraviolet rays, there is no necessity of preparing the photomask M2, and therefore the uncured UV curable liquid crystal can be easily cured.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for manufacturing a liquid crystal display device, the method comprising:
forming a structure on a first substrate;
bonding a second substrate onto the structure to form a first space and a second space which are isolated by the structure between the first substrate and the second substrate;
injecting a first liquid crystal material containing a photo-curable resin into one of the first space and the second space while selectively irradiating a boundary area of the first space and the second space with a light; and
injecting a second liquid crystal material different from the first liquid crystal material into another one of the first space and the second space.

2. The method for manufacturing a liquid crystal display device according to claim 1, the method further comprising:
after the injecting a first liquid crystal material, irradiating the first liquid crystal material with a light for curing the photo-curable resin.

3. The method for manufacturing a liquid crystal display device according to claim 2, wherein
the irradiating the first liquid crystal material includes selectively irradiating a portion of the first liquid crystal material, the portion existing in the vicinity of a wall surface of the structure with the light for curing the photo-curable resin.

4. The method for manufacturing a liquid crystal display device according to claim 1, wherein
the second liquid crystal material contains a photo-curable resin; and
the injecting a second liquid crystal material is performed upon injecting the first liquid crystal material.

5. The method for manufacturing a liquid crystal display device according to claim 4, the method further comprising:
after the injecting a second liquid crystal material, irradiating the second liquid crystal material with a light for curing the photo-curable resin.

6. The method for manufacturing a liquid crystal display device according to claim 5, wherein
the irradiating the second liquid crystal material includes selectively irradiating a portion of the second liquid crystal material, the portion existing in the vicinity of a wall surface of the structure with the light for curing the photo-curable resin.

7. A method for manufacturing a liquid crystal display device, the method comprising:
forming a photosensitive film on a first substrate;
exposing the photosensitive film to form an exposure pattern on the photosensitive film using an exposure mask;
developing the photosensitive film to form a structure corresponding to the exposure pattern of the photosensitive film on the first substrate;
bonding a second substrate onto the structure to form a first space and a second space which are isolated by the structure between the first substrate and the second substrate;
injecting a first liquid crystal material containing a photo-curable resin into one of the first space and the second space while irradiating a gap between the first substrate and the second substrate using the exposure mask; and
injecting a second liquid crystal material different from the first liquid crystal material into another one of the first space and the second space.

8. The method for manufacturing a liquid crystal display device according to claim 7, the method further comprising:
after the injecting a first liquid crystal material, irradiating the first liquid crystal material with a light for curing the photo-curable resin.

9. The method for manufacturing a liquid crystal display device according to claim 8, wherein
the irradiating the first liquid crystal material includes selectively irradiating an area corresponding to the exposure pattern and a portion of the first liquid crystal material, the portion existing in the vicinity of a wall surface of the structure with a light for curing the photo-curable resin using a curing mask different from the exposure mask.

10. The method for manufacturing a liquid crystal display device according to claim 8, wherein
the second liquid crystal material contains a photo-curable resin; and
the injecting a second liquid crystal material is performed upon injecting the first liquid crystal material.

11. The method for manufacturing a liquid crystal display device according to claim 1, wherein
the photo-curable resin is a UV curable liquid crystal.

12. A liquid crystal display device comprising:
a first substrate and a second substrate facing each other;
a structure which is provided between the first substrate and the second substrate and divides a gap between the first substrate and the second substrate into a first space and a second space;
a first liquid crystal material which is injected into the first space; and
a second liquid crystal material which is injected into the second space,
wherein at least one portion of the structure is formed with a cured body of a photo-curable resin.

13. The liquid crystal display device according to claim 12, wherein
the cured body of the photo-curable resin is formed on the wall surface of the structure.

14. The liquid crystal display device according to claim 12, wherein
the photo-curable resin is a UV curable liquid crystal.
